(19) United States
(12) Patent Application Publication
(10) Pub. No.: US 2009/0172743 A1
(43) Pub. Date: Jul. 2, 2009

(54) METHOD FOR UTILIZING AT LEAST ONE SIGNAL-RECEIVING MODULE TO RECORD MULTIMEDIA PROGRAMS AND SYSTEM THEREOF

(76) Inventor: Jian-Feng Feng, Hefei (CN)

Correspondence Address: NORTH AMERICA INTELLECTUAL PROPERTY CORPORATION, P.O. BOX 506, MERRIFIELD, VA, 22116, US

(21) Appl. No.: 12/034,669

(22) Filed: Feb. 21, 2008

(30) Foreign Application Priority Data
Jan. 2, 2008 (CN) 200810000113.6

(51) Int. Cl. G06F 3/00

(52) U.S. Cl. 725/58

(57) ABSTRACT

The present invention discloses a method for utilizing at least one signal-receiving module to record multimedia programs and system thereof. The method includes utilizing a first signal-receiving module to receive a multimedia stream corresponding to a plurality of channels and supplying an output content corresponding to a selected channel; setting a time interval; and when a user switches a previously selected channel to a currently selected channel, starting to count a duration corresponding to the currently selected channel, and controlling a recording operation of an output content of the currently selected channel supplied by the first signal-receiving module according to the duration and the time interval.

### Background

The present invention relates to a multimedia stream recording approach, and more particularly, to a method for utilizing at least one signal-receiving module to record multimedia programs and system thereof.

Generally, when a user switches signal sources (e.g. channels) during a multimedia program recording process, then television program recording devices also record some unneeded video/audio garbage, and accordingly reasons for producing this above-mentioned video/audio garbage are frequently that the user is random switching signal sources or avoiding advertisements. As a result, the recorded content does not conform with the user's needed content. Accordingly, the prior art recording device is very inconvenience for the user to record the multimedia program.

Please refer to FIG. 1, FIG. 1 is a flowchart of a first operation for utilizing a prior art recording device to record multimedia programs. As shown in FIG. 1, in Step 100, a user first displays a first channel, i.e. the currently selected channel. Then, in Step 102, when the user decides to record the first channel, the user starts a prior art recording device to record a multimedia program of the selected first channel. In Step 104, during recording of the first channel process, the user switches signal sources into a second channel which is different from the first channel, and the user does wish to record the second channel (i.e. after a short period time, the user also switches the second channel into another channel, in other words, for the recording operation, then the second channel is a unstable signal source because a duration of the second channel is not enough long). In addition, in Step 106, the prior art recording device also records contents of the second channel. Then, in Step 108, the user switches the signal channel to a third channel again, and the third channel is a new channel recorded by the user (i.e. after a short period time, the user does not switch the third channel to another channel, in otherwords, for the recording operation, the third channel is a stable signal source because a duration of the third channel is long enough). In Step 110, then the prior art recording device changes recording sources to the third channel and records multimedia programs of the third channel. In above-mentioned prior art, the second channel shown in FIG. 1 is the unneeded multimedia program for the user, but the prior art recording device also records the content of the second channel in the short time which the second channel is switched to the third channel.

Please refer to FIG. 2, FIG. 2 is a flowchart of a second operation for utilizing a prior art recording device to record multimedia programs. As shown in FIG. 2, in Step 200, a user first displays a first channel, i.e. the currently selected channel. Then, in Step 202, when the user decides to record the first channel, the user starts a prior art recording device to record multimedia programs of the selected first channel. In Step 204, during the recording of the first channel process, the user switches signal sources into a second channel, and the user does not really wish to record the second channel. But, in Step 206, the prior art recording device also records contents of the second channel. Then, in Step 208, the user switches again the signal source to the original first channel. In addition, in Step 210, then the prior art recording device changes recording sources to the first channel and records multimedia programs of the first channel. In above-mentioned prior art, the second channel shown in FIG. 2 is the unneeded multimedia programs for a user, but the prior art recording device also records the second channel, and resultingly there are many unneeded audio/video information mixed in the content of the multimedia programs of the recorded first channel.

### SUMMARY

It is therefore one of the objectives of the claimed invention to provide a method for utilizing at least one signal-receiving module to record multimedia programs and system thereof, to solve the above-mentioned problems and enhance image quality.

According to one embodiment of the claimed invention, a method for utilizing at least one signal-receiving module to record multimedia programs is disclosed. The method comprises: utilizing a first signal-receiving module to receive a multimedia stream corresponding to a plurality of channels and supplying an output content corresponding to a selected channel; setting a time interval; and when a user switches a previously selected channel to a currently selected channel, starting to count a duration corresponding to the currently selected channel, and controlling a recording operation of an output content of the currently selected channel supplied by the first signal-receiving module according to the duration and the time interval.

According to yet another embodiment of the present invention, a system for utilizing at least one signal-receiving module to record multimedia programs is disclosed. The system comprises: a first signal-receiving module, for receiving a multimedia stream corresponding to a plurality of channels and supplying an output content corresponding to a selected channel; a time-setting module, for setting a time interval; a first recording module, coupled to the first signal-receiving module, for recording the output content of the currently selected channel; and a processing module, coupled to the time-setting module and the first recording module, for when a user switches a previously selected channel to a currently selected channel, starting to count a duration corresponding to the currently selected channel, and controlling a recording operation of an output content of the currently selected channel supplied by the first signal-receiving module according to the duration and the time interval.

In conclusion, through a method for utilizing at least one signal-receiving module to record multimedia programs and system thereof disclosed by the present invention, when a user switches multimedia program sources (television channel or other audio and video sources) in a multimedia programs recording process, then some unneeded video/audio garbage will not be recorded. As a result, the recorded multimedia programs are needed and wanted multimedia programs for the user, and system resources are not wasted.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flowchart of a first operation for utilizing a prior art recording device to record multimedia programs.

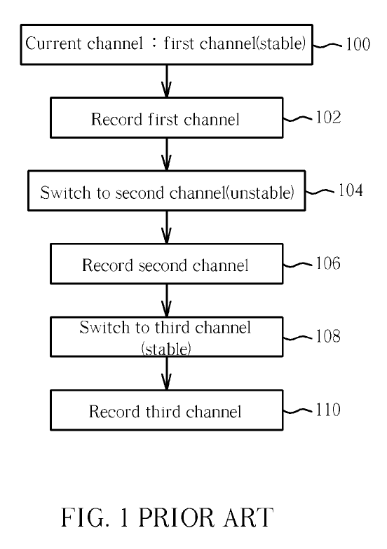

FIG. 2 is a flowchart of a second operation for utilizing a prior art recording device to record multimedia programs.

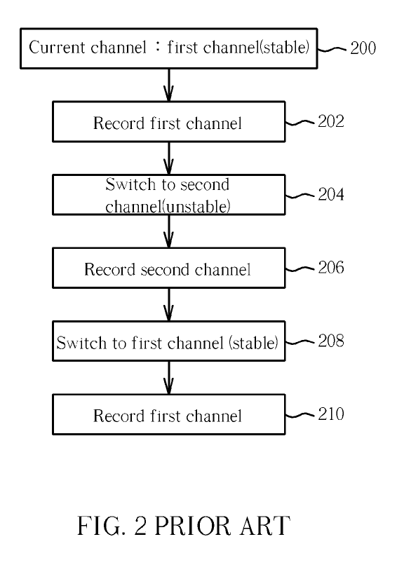

FIG. 3 is a block diagram illustrating a system for applying one signal-receiving module and one recording module to record multimedia programs according to one embodiment of the present invention.

FIG. 4 is a flowchart illustrating a method for applying one signal-receiving module and one recording module to record multimedia programs according to one embodiment of the present invention.

FIG. 5 is a flowchart illustrating operation examples for applying one signal-receiving module and one recording module to record multimedia programs according to one embodiment of the present invention.

FIG. 6 is a block diagram illustrating a system for applying two signal-receiving modules and one recording module to record multimedia programs according to one embodiment of the present invention.

FIG. 7 is a flowchart illustrating a method for applying two signal-receiving modules and one recording module to record multimedia programs according to one embodiment of the present invention.

FIG. 8 is a flowchart illustrating operation examples for applying two signal-receiving modules and one recording module to record multimedia programs according to one embodiment of the present invention.

FIG. 9 is a block diagram illustrating a system for applying two signal-receiving modules and two recording modules to record multimedia programs according to one embodiment of the present invention.

FIG. 10 is a flowchart illustrating a method for applying two signal-receiving modules and two recording modules to record multimedia programs according to one embodiment of the present invention.

FIG. 11 is a flowchart illustrating operation examples for applying two signal-receiving modules and two recording modules to record multimedia programs according to one embodiment of the present invention.

### DETAILED DESCRIPTION

Certain terms are used throughout the following description and claims to refer to particular system components. As one skilled in the art will appreciate, manufacturers may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ” The terms “couple” and “couples” are intended to mean either an indirect or a direct electrical connection. Thus, if a first device couples to a second device, that connection may be through a direct electrical connection, or through an indirect electrical connection via other devices and connections.

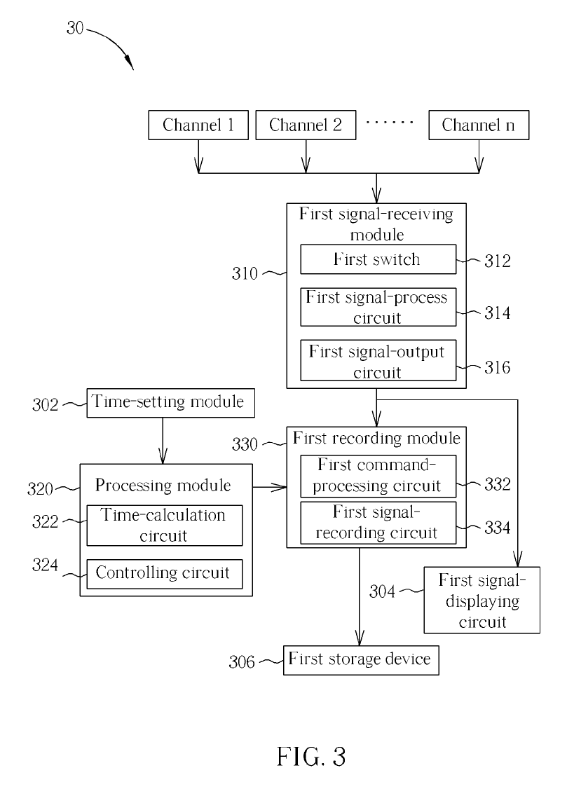

Please refer to FIG. 3. FIG. 3 is a block diagram illustrating a system 30 for applying one signal-receiving module and one recording module to record multimedia programs according to one embodiment of the present invention. As shown in FIG. 3, the system 30 includes a first signal-receiving module 310, a time-setting module 302, a processing module 320, a first signal-displaying circuit 304, a first recording module 330, and a first storage device 306. The first signal-receiving module 310 is coupled to a plurality of channels (e.g. without limitation channel 1, channel 2 and channel n), for receiving a multimedia stream corresponding to a plurality of channels and supplying an output content corresponding to a selected channel. As shown in FIG. 3, the first signal-receiving module 310 includes a first switch 312, a first signal-processing circuit 314 and a first signal-output circuit 316. The first switch 312 is utilized to switch a plurality of channels (e.g. without limitation channel 1, channel 2 and channel n). In this embodiment, the multimedia stream is a plurality of signal sources, and each signal source is corresponding to a channel. Accordingly, the first switch 312 is applied as a multiplexer for selecting to output a signal source corresponding to one channel from the plurality of signal sources. Furthermore, in other embodiments, the multimedia stream may be a television signal source, and each channel is a television channel. In addition, the first switch 312 may also be applied as a tuner for selecting to output program information corresponding to one television channel from the plurality of television channels. In conclusion, sources of the plurality of channels may be any form of television channels, AV terminals, digital video (DV), multimedia player (e.g. without the limitation of being a DVD player) or other entertainment equipment.

The first signal-processing circuit 314 is coupled to the first switch 312 for processing the multimedia stream and decoding the multimedia stream, and decodes the multimedia stream to one signal information corresponding to the system 30. The first signal-output circuit 316 receives the decoded multimedia stream sent by the first signal-processing circuit 314, and supplies an output content corresponding to the selected channel to output the output content into the first signal-displaying circuit 304 and the first recording module 330, wherein the first signal-displaying circuit 304 is utilized for displaying the output content corresponding to the selected channel supplied by the first signal-output circuit 316 in a displaying device (not shown), for example, a television screen or a computer monitor. Then, the first recording module 330 is utilized for recording the output content corresponding to the selected channel, and recording operations of the first recording module 330 may further include suitable controls to prevent recording unneeded audio/video garbage. The details are described as follows.

Time-setting module 302 is utilized for setting a time interval (for example, 5 minutes but without limitation of this value), i.e. the time interval may be set by a user or by the system 30 according to a predetermined time interval. In addition, a unit of the time interval may be in a form of minutes, seconds, or combination of minutes and seconds. The time interval is a basis for controlling recording operations of the multimedia stream. Therefore, the time interval should not be unsuitably long.

The processing module 320 is coupled to the time interval 302 for when the user switches a previously selected channel to a currently selected channel, the processing module 320 starts to count a duration corresponding to the currently selected channel, and controlling a recording operation of an output content of the currently selected channel supplied by the first signal-receiving module 310 for the first recording module 330 according to the duration and the time interval set by the time-setting module 302, wherein the processing module 320 further includes a time-calculation circuit 322 and a controlling circuit 324. The time-calculation circuit 322 is utilized for counting the duration sent continuously by the multimedia stream, i.e. the duration stayed by the multimedia stream of the current channel selected by the user. The controlling circuit 324 is utilized for controlling a recording operation of an output content of the currently selected channel supplied by the first signal-receiving module 310 according to the duration and the time interval.

When the duration of the multimedia stream is not longer than the time interval set by the time-setting module 302, then the controlling circuit 321 transmits a pause command to the first recording module 330 for pausing the first recording module 330 from recording the output content of the currently selected channel until the duration is longer than the time interval, and at this time the multimedia stream is an unstable signal. When the duration is longer than the time interval, then the controlling circuit 324 transmits a resume command to the first recording module 330 for resuming the first recording module 330 to record the output content of the currently selected channel, and at this time, the multimedia is a stable signal. The first recording module 330 is coupled to the processing module 320, wherein the first recording module 330 further includes a first command-processing circuit 332 and a first signal-recording circuit 334. When the first command-processing circuit 332 receives the pause command transmitted by the controlling circuit 324, the first command-processing circuit 332 pauses the first recording module 330 from recording the output content of the current channel selected by the user. On the other hand, when the first command-processing circuit 332 receives the resume command transmitted by the controlling circuit 324, the first command-processing circuit 332 resumes the first recording module 330 to record the output content of the currently selected channel. The first signal-recording circuit 334 is utilized for recording the multimedia stream corresponding to the output content of the currently channel selected by the user, and transmits recorded data to the first storage device 306, wherein the first storage device 306 may be an external storage device or an internal storage device embedded in the system 30, and the first storage device 306 may be a hard disk (HD), an optical storage, a non-volatile memory or other device with storage functionality.

It should be noted that the form of the pause command or the resume command may be a string, an acknowledge character (ACK), a binary (e.g. without limitation 0 may describes pause, 1 may describe resume), or a signal having controlling information.

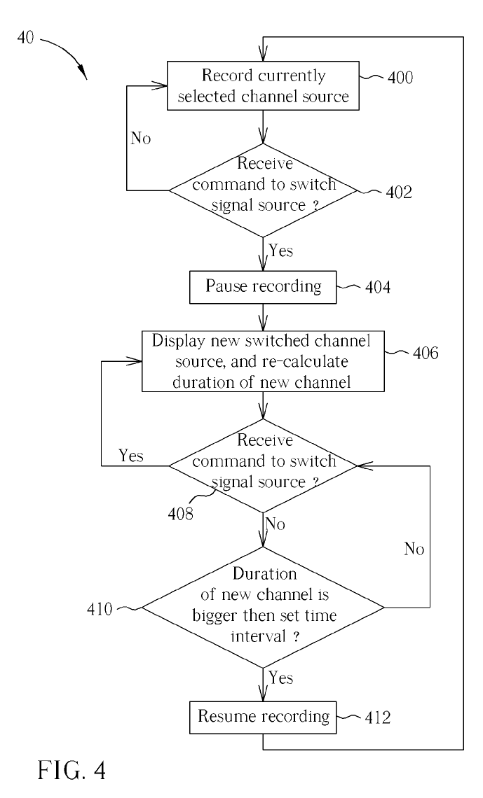

Please refer to FIG. 3 in conjunction with FIG. 4. FIG. 4 is a flowchart illustrating a method for applying one signal-receiving module and one recording module to record multimedia programs according to one embodiment of the present invention. Please note that, provided that substantially the same result is achieved, the steps of the flowchart shown in FIG. 4 need not be in the exact order shown and need not be contiguous, that is, other steps can be intermediate.

As flow 40 shows in FIG. 4, in Step 400, when the system 30 receives at least a recording channel source needed by the user (i.e. a stable signal source, for example, without limitation a television program or an Av media source), the processing module 320 of the system 30 starts the first recording module 330 to record a current channel source needed by the user. After, in Step 402, it is executed to determine whether the first switch 312 receives commands to switch channel sources, i.e. the user randomly switches the channel sources, and at this time, the channel source is a unstable signal, in other words, a duration of the selected channel is not longer than a time interval set by the time-setting module 302 of the system 30. If the result determined by Step 402 is false, then the flow 40 returns to Step 400 to continuously execute; if the result determined by Step 402 is true, then flow 40 continues onto Step 404. In Step 404, the controlling circuit 324 of the processing module 320 in the system 30 controls the first recording module 330 for pausing to record the currently channel source need by the user. Then, in Step 406, the first signal-displaying circuit 304 starts to display the new channel source switched by the user, and the time-calculation circuit 322 of the processing module 320 re-calculates to count a duration of the new channel. Furthermore, in Step 408, it is executed to determine whether the first switch 312 receives the command to switch channel sources, i.e. the user randomly switches the channel sources. If the result determined by Step 408 is true, then the flow 40 returns back to Step 406; if the result determined by Step 408 is false, then the flow 40 continues onto Step 410 to continuously monitor whether or not the duration of the selected channel is longer than the time interval set by the time-setting module 302.

In Step 410, the controlling circuit 324 shown in FIG. 3 detects whether the duration of the new channel longer than the time interval set by the time-setting module 302. If the detected result of Step 410 is false, then the flow 40 returns back to Step 408. Contrarily, if the detected result of Step 410 is true, the flow 40 continues onto Step 41 2. For example, if the duration is currently 3 minutes, and the time interval is 5 minutes, then Step 410 detects that the duration is not longer than the time interval, in addition, the duration and the time interval also can be represented with seconds as time unit, or represented with a suitable time unit, wherein the suitable time unit is not so long a time unit to affect data recording seriously. When the counted duration is longer than the time interval set by the time-setting module 302, then in Step 410, the controlling circuit 324 controls the first signal-recording circuit 334 to resume for recording the currently channel source needed by the user. At this moment, when the duration of the new channel source is longer than the time interval set by the time-setting module 302, the new channel source is a stable signal. As a result, the flow 40 returns back to Step 400 to continuously perform the aforementioned flow until the system 30 completes the recording operations of the needed channel data for the user.

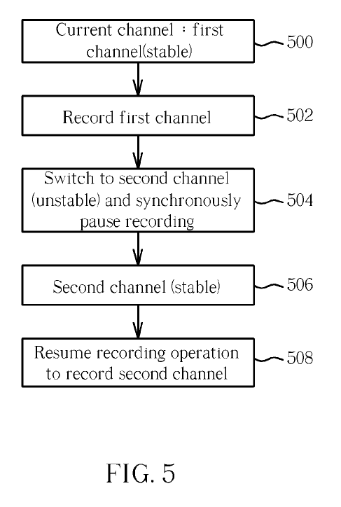

Please refer to FIG. 3 and FIG. 4 in conjunction with FIG. 5. FIG. 5 is a flowchart illustrating operation examples for applying one signal-receiving module and one recording module to record multimedia programs according to one embodiment of the present invention. As shown in FIG. 5, in Step 500, a user first displays a first channel, i.e. currently selected channel. Then, in Step 502, when the user decides to record the first channel, the user starts the system 30 shown in FIG. 3 of the present invention to record the selected first channel, wherein the first channel is a stable signal. In Step 504, the user switches the signal source to a second channel in the recording first channel process. And the second channel is not the needed channel for the user, i.e. the second channel is an unstable signal source, in other words, a duration of the second channel is not longer than the time interval set by the system 30 shown in FIG. 3. At this time, the system 30 shown in FIG. 3 automatically pauses recording operations synchronously to prevent recording unneeded data for the user. In Step 506, when the duration of the second channel is counted and longer than the time interval, the second channel is a stable signal. Then, in Step 508, the system 30 shown in FIG. 3 resumes recording the second channel. It should be noted that the above=mentioned flow may be executed repeatedly until the recording operations is completed. Furthermore, the aforementioned example is for illustrative purposes only and is not meant to be a limitation of the present invention.

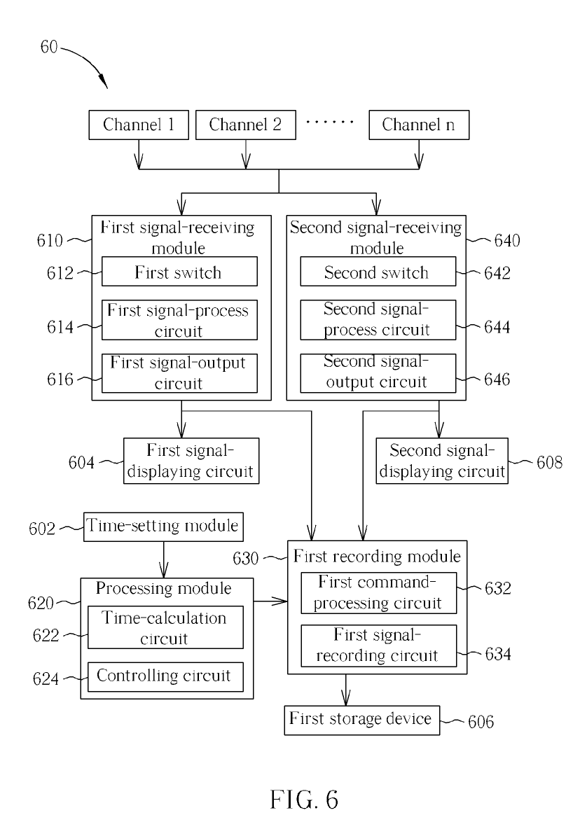

Please refer to FIG. 6. FIG. 6 is a block diagram illustrating a system 60 for applying two signal-receiving modules and one recording module to record multimedia programs according to one embodiment of the present invention. As shown in FIG. 6, the system 60 includes a first signal-receiving module 610, a second signal-receiving module 640, a time-setting module 602, a processing module 620, a first signal-displaying circuit 604, a second signal-displaying circuit 608, a first recording module 630 and a first storage device 606. In this embodiment, the first signal-receiving module 610 includes a first switch 612, a first signal-processing circuit 614 and a first signal-output circuit 616; in addition, the second signal-receiving module 640 includes a second switch 642, a second signal-processing circuit 644 and a second signal-output circuit 61 6. The first recording module 630 includes a first command-processing circuit 632 and a first signal-recording circuit 634.

In FIG. 6, architectures and theorems of the first and second signal-receiving module 610, 640, the time-setting module 602, the first signal-displaying circuit 604, the first recording module 630 and the first storage device 606 are same respectively as architectures and theorems of the first and second signal-receiving module 310, 340, the time-setting module 302, the first signal-displaying circuit 304, the first recording module 330 and the first storage device 306 shown in FIG. 3, further descriptions are omitted here for the sake of brevity. The processing module 620 is utilized for when a user switches a previously selected channel to a currently selected channel, starting to count a duration corresponding to the currently selected channel, and controlling a recording operation of an output content of the currently selected channel supplied by the first signal-receiving module 610 according to the duration and the time interval, wherein the processing module 620 further includes a time-calculation circuit 622 and a controlling circuit 634. Architecture and theorem of the time-calculation circuit 622 is same as architecture and theorem of the time-calculation circuit 322 shown in FIG. 3, further description is omitted here for the sake of brevity. In this embodiment, if the first signal-receiving module 610 is utilized for supplying an output content of the currently selected channel, and the second signal-receiving module 640 is utilized for supplying an output content of the previously selected channel, in other words, when the user switches a previously selected channel (selected by the second switch 642) to a currently selected channel (selected by the first switch 61 2), the controlling circuit 624 controls the first recording module 630 for pausing recording of the output content of the currently channel selected by the first switch 612 until the duration is longer than the time interval; and controls the first recording module 630 for continuously recording the output content corresponding to the previously selected channel supplied by the second signal-receiving module 640 until the duration is longer than the time interval.

It should be noted that, when the current channel selected by the first switch 612 is a stable signal, then next channel switched by the user is selected by the second switch 642. At this time, the channel selected by the first switch 612 becomes the previous channel, and the channel selected by the second switch 642 becomes the current channel. In this embodiment, the present invention does not limit the first switch 612 or the second switch 642 to select the previous channel or the current channel. The aforementioned example is for illustrative purposes only and is not meant to be a limitation of the present invention.

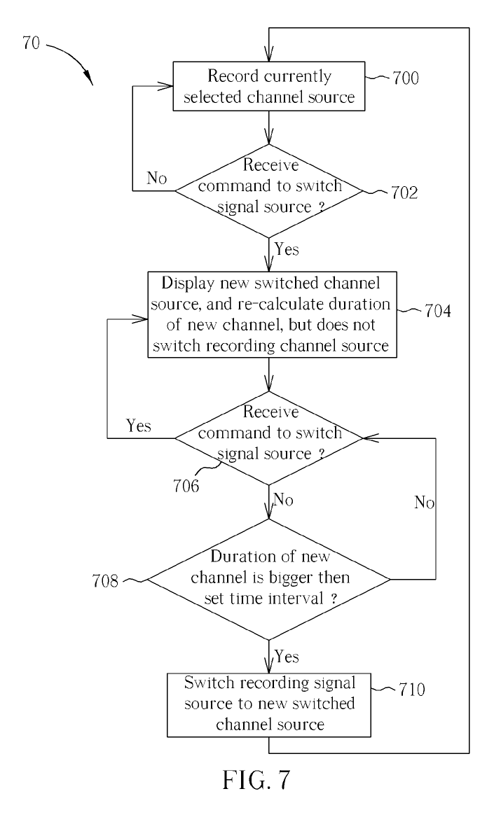

Please refer to FIG. 6 in conjunction with FIG. 7. FIG. 7 is a flowchart illustrating a method for applying two signal-receiving modules and one recording module to record multimedia programs according to one embodiment of the present invention. Please note that, provided that substantially the same result is achieved, the steps of the flowchart shown in FIG. 7 need not be in the exact order shown and need not be contiguous, that is, other steps can be intermediate. As flow 70 shows in FIG. 7, in Step 700, when the system 60 receives at least a recording channel source needed by the user (i.e. a stable signal source, for example, without limitation a television program or an Av media source), the processing module 620 of the system 60 starts the first recording module 630 to record a current channel source needed by the user. After, in Step 702, it is executed to determine whether the first switch 612 receives commands to switch channel sources, i.e. the user randomly switches the channel sources, and at this time, the channel source is a unstable signal, in other words, a duration of the selected channel is not longer than a time interval set by the time-setting module 602 of the system 60. If the result determined by Step 702 is false, then the flow 70 returns to Step 700 to continuously execute. If the result determined by Step 702 is true, then flow 70 continues onto Step 704. In Step 704, the controlling circuit 624 of the processing module 620 selects the first signal-displaying circuit 604 to display the new currently selected channel source, and the time-calculation circuit 622 of the processing module 620 re-calculates duration of the new channel. At this time, the first recording module 630 does not change the recording channel source (i.e. output of the second signal-receiving module 640) and does not pause recording the previous channel source needed by the user. In Step 706, it is executed to determine whether the first switch 612 receives the command to switch channel sources, i.e. the user randomly switches the channel sources. If the result determined by Step 706 is true, then the flow 70 returns back to Step 704. If the result determined by Step 706 is false, then the flow 70 continues onto Step 708. In Step 708, the controlling circuit 624 shown in FIG. 6 detects whether the duration the new channel (i.e. the channel selected by the first switch 612) is longer than a time interval set by the time-setting module 602 shown in FIG. 6. If the detected result of Step 708 is false, then the flow returns back to Step 706. If the result determined by Step 708 is false, then the flow 70 continues onto Step 710. In Step 710, when the duration is longer than the time interval, then the controlling circuit 624 of the processing module 620 controls the first recording module 630 to switch the recording signal source into the new currently selected channel source, to record the new switched channel, i.e. the first recording module 630 starts to record the output of the first signal-receiving module 610 (corresponding to the currently selected channel), and does not record the output of the second signal-receiving module 640 (corresponding to the previously selected channel). As a result, the flow 70 returns back to Step 700 continuously to perform the aforementioned flow until the system 60 completes the recording operations of the needed channel data for the user.

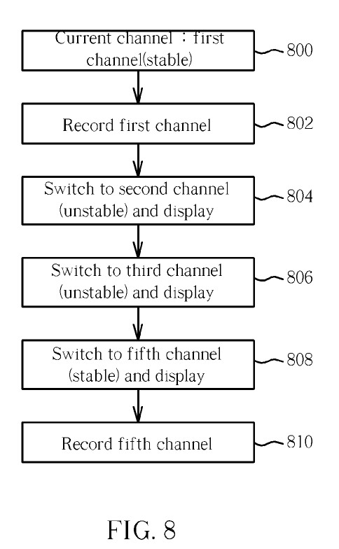

Please refer to FIG. 6 and FIG. 7 in conjunction with FIG. 8. FIG. 8 is a flowchart illustrating operation examples for applying two signal-receiving modules and one recording module to record multimedia programs according to one embodiment of the present invention. As shown in FIG. 8, in Step 800, a user first displays a first channel, i.e. currently selected channel. Then, in Step 802, when the user decides to record the first channel, the user starts the system 60 shown in FIG. 6 of the present invention to record the selected first channel, wherein the first channel is a stable signal. In Step 804, the user switches the signal source to a second channel in the recording first channel process. And the second channel is not the needed channel for the user, i.e. the second channel is an unstable signal source, in other words, duration of the second channel is not longer than the time interval set by the system 60 shown in FIG. 6. At this time, if the first switch 612 selects the second channel, and the second switch 642 selects the first channel, then the first signal-displaying circuit 604 shown in FIG. 6 starts to display the second channel, but the first recording module 630 still continuously records the first channel.

In Step 806, the user switches the signal source to a third channel and the third channel is not the needed channel for the user, i.e. duration of the third channel is not longer than the time interval set by the system 60 shown in FIG. 6. At this time, the first switch 612 selects the second channel, and the second switch 642 selects the third channel. Therefore, the second signal-displaying circuit 608 shown in FIG. 6 starts to display the third channel, but the first recording module 630 still continuously records the first channel. In Step 808, the user switches the signal source to a fifth channel and duration of the fifth channel is be counted until the duration is longer than the time interval, then the fifth channel is a stable signal, in other words, the fifth channel is a recording signal source needed by the user. Next, in Step 810, the system 60 shown in FIG. 6 switches the first recording module 630 to record the fifth channel, not record the content of the previously selected channel (i.e. the above-mentioned first channel). It should be noted that the above=mentioned flow may be executed repeatedly until the recording operation is completed. Furthermore, the aforementioned example is for illustrative purposes only and is not meant to be a limitation of the present invention.

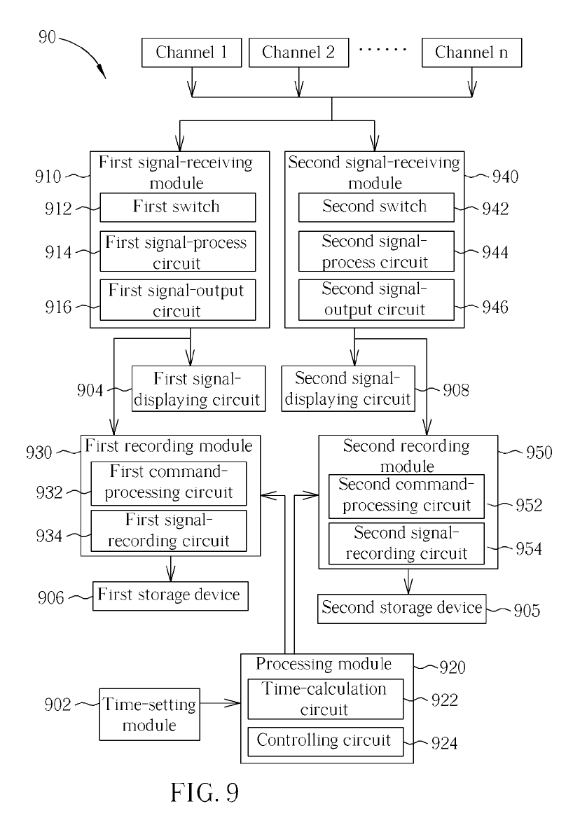

Please refer to FIG. 9. FIG. 9 is a block diagram illustrating a system 90 for applying two signal-receiving modules and two recording modules to record multimedia programs according to one embodiment of the present invention. As shown in FIG. 9, the system 90 includes a first signal-receiving module 910, a second signal-receiving module 940, a time-setting module 902, a processing module 920, a first signal-displaying circuit 904, a second signal-displaying circuit 908, a first recording module 930, a first storage device 906, a second recording module 950 and a second storage device 910. In this embodiment, the first signal-receiving module 910 includes a first switch 912, a first signal-processing circuit 914 and a first signal-output circuit 916. In addition, the second signal-receiving module 940 includes a second switch 942, a second signal-processing circuit 944 and a second signal-output circuit 916. The first recording module 930 includes a first command-processing circuit 932 and a first signal-recording circuit 934. The second recording module 950 includes a second command-processing circuit 952 and a second signal-recording circuit 954. In FIG. 9, architectures and theorems of the first and second signal-receiving module 910, 940, the time-setting module 902, the first signal-displaying circuit 904, the first recording module 930, the first storage device 906 and the second storage device 905 are same respectively as architectures and theorems of the first and second signal-receiving module 610, 640, the time-setting module 602, the first signal-displaying circuit 604, the first recording module 630 and the first storage device 606 shown in FIG. 6, further descriptions are omitted here for the sake of brevity.

The processing module 920 is utilized for when a user switches a previously selected channel to a currently selected channel, starting to count a duration corresponding to the currently selected channel, and controlling a recording operation of an output content of the currently selected channel supplied by the first signal-receiving module 910 according to the duration and the time interval, wherein the processing module 920 further includes a time-calculation circuit 922 and a controlling circuit 934. However, architecture and theorem of the time-calculation circuit 922 is same as architecture and theorem of the time-calculation circuit 622 shown in FIG. 6, further description is omitted here for the sake of brevity. In this embodiment, the controlling circuit 924 controls a recording operation of an output content of the currently selected channel according to the duration and the time interval. For example, the first signal-receiving module 910 supplies an output content of the currently selected channel, and the second signal-receiving module 940 supplies an output content of the previously selected channel. Accordingly, when the user switches a previously selected channel selected by the second switch 942 to a currently selected channel selected by the first switch 912, the controlling circuit 924 controls the first recording module 630 for pausing recording of the output content of the currently channel selected by the first switch 612 until the duration is longer than the time interval. After the content of the currently selected channel is recorded, then the controlling circuit 924 further controls the second recording module 950 continuously to record the output content of the previously selected channel for at least a period time.

It should be noted that when the user switches the previous channel selected by the second switch 942 to the current channel selected by the first switch 612, the controlling circuit 924 does not pause the second recording module 950 to record the output content of the previously selected channel, in other words, when the first recording module 930 pauses recording of the output content of the currently selected channel, the second recording module 950 still continuously records the output content of the previously selected channel. In addition, in this embodiment, the recording results of the first recording module 930 and the second recording module 950 are respectively stored in the first storage device 906 and the second storage device 905, and the system 90 further retrieves completed recording information respectively from the first storage device 906 and the second storage device 905, to combine as a customized multimedia information according to need of the user.

On the other hand, when the current channel selected by the first switch 912 is a stable signal, then next channel switched to by the user is selected by the second switch 942. At this time, the channel selected by the first switch 912 becomes the previous channel, and the channel selected by the second switch 942 becomes the current channel. In this embodiment, the present invention does not limit the first switch 912 or the second switch 942 to select the previous channel or the current channel. The aforementioned example is for illustrative purposes only and is not meant to be a limitation of the present invention.

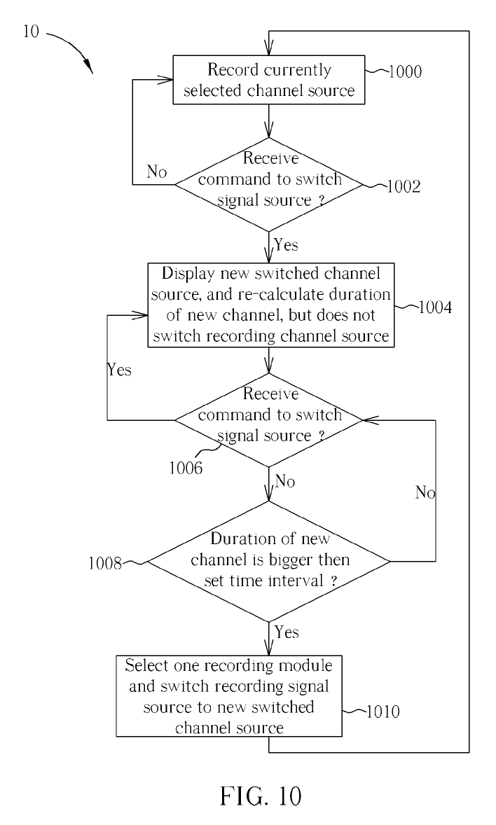

Please refer to FIG. 9 in conjunction with FIG. 10. FIG. 10 is a flowchart illustrating a method for applying two signal-receiving modules and two recording modules to record multimedia programs according to one embodiment of the present invention. Please note that, provided that substantially the same result is achieved, the steps of the flowchart shown in FIG. 10 need not be in the exact order shown and need not be contiguous, that is, other steps can be intermediate. As flow 10 shows in FIG. 10, in Step 1000, when the system 90 receives at least a recording channel source needed by the user (i.e. a stable signal source, for example, without limitation television program or Av media source), the processing module 920 of the system 90 starts the first recording module 930 to record a current channel source needed by the user. After, in Step 1002, it is executed to determine whether the first switch 912 receives commands to switch channel sources, i.e. the user randomly switches the channel sources, and at this time, the channel source is a unstable signal, in other words, a duration of the selected channel is not longer than a time interval set by the time-setting module 902 of the system 90. If the result determined by Step 1002 is false, then the flow 10 returns to Step 1000 to continuously execute. If the result determined by Step 1002 is true, then flow 70 continues onto Step 1004. In Step 1004, the first signal-displaying circuit 904 displays the new currently selected channel source, and the time-calculation circuit 922 of the processing module 920 re-calculates duration of the new channel, at this time, the second recording module 950 does not change the recording channel source and does not pause to record the previous channel source needed by the user. In Step 1006, it is executed to determine whether the second switch 942 receives the command to switch channel sources, i.e. the user randomly switches the channel sources. If the result determined by Step 1006 is true, and then the flow 10 returns back to Step 1004. If the result determined by Step 1006 is false, then the flow 10 continues onto Step 1008. In Step 1008, the controlling circuit 924 shown in FIG. 9 detects whether the duration of the new channel is longer than a time interval set by the time-setting module 902 shown in FIG. 9. If the detected result of Step 1008 is false, then the flow returns back to Step 1006. If the result determined by Step 1008 is false, then the flow 10 continues onto Step 1010. In Step 1010, the controlling circuit 924 of the processing module 920 selects a recording module (in this embodiment, the first recording module 930 is selected), and switches the recording signal source to the new selected channel source. As a result, the flow 10 returns back to Step 1000 continuously perform the aforementioned flow until the system 90 completes the recording operations of the needed channel data for the user.

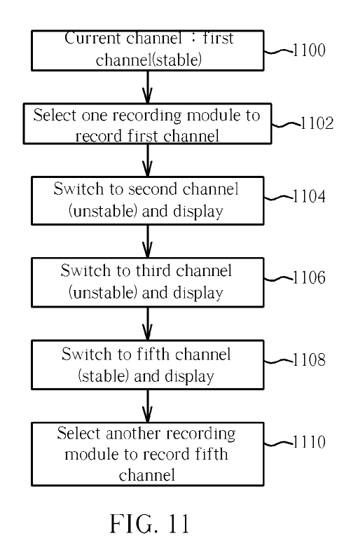

Please refer to FIG. 9 and FIG. 10 in conjunction with FIG. 11. FIG. 11 is a flowchart illustrating operation examples for applying two signal-receiving modules and two recording modules to record multimedia programs according to one embodiment of the present invention. As shown in FIG. 11, in Step 1100, a user first displays a first channel, i.e. a currently selected channel. Then, in Step 1102, when the user decides to record the first channel, the user starts the system 90 shown in FIG. 9 of the present invention to record the selected first channel, wherein the first channel is a stable signal.

In Step 1104, the user switches the signal source to a second channel in the recording first channel process. And the second channel is not the needed channel for the user, i.e. the second channel is an unstable signal source, in other words, duration of the second channel is not longer than the time interval set by the system 90 shown in FIG. 9. At this time, the system 90 may select the first signal-displaying circuit 904 shown in FIG. 9 to display the second channel (currently selected channel), accordingly, the second recording module 950 still continuously records the first channel (previously selected channel). In Step 1006, the user still switches the signal source to a third channel and the third channel is not the needed channel for the user, i.e. duration of the third channel is not longer than the time interval set by the system 90 shown in FIG. 9. At this time, the system 90 may select the first signal-displaying circuit 904 shown in FIG. 9 to display the third channel, accordingly, the second recording module 950 still continuously records the first channel. In Step 1008, the user still switches the signal source to a fifth channel and duration of the fifth channel is be counted until the duration is longer than the time interval, then the fifth channel is a stable signal, in other words, the fifth channel is a recording signal source needed by the user. Next, in Step 1110, the system 90 shown in FIG. 9 selects another recording module (i.e. the first recording module 930) to record the fifth channel. It should be noted that the above=mentioned flow may be executed repeatedly until the recording operations is completed. Furthermore, the aforementioned example is for illustrative purposes only and is not meant to be a limitation of the present invention.

Those skilled in the art will readily observe that numerous modifications and alterations of the device and method may be made while retaining the teachings of the invention.

What is claimed is:

1. A method for utilizing at least one signal-receiving module to record multimedia programs, comprising:
utilizing a first signal-receiving module to receive a multimedia stream corresponding to a plurality of channels and supplying an output content corresponding to a selected channel;
setting a time interval; and
when a user switches a previously selected channel to a currently selected channel, starting to count a duration corresponding to the currently selected channel, and controlling a recording operation of an output content of the currently selected channel supplied by the first signal-receiving module according to the duration and the time interval.

2. The method of claim 1, wherein the step of controlling a recording operation of an output content of the currently selected channel supplied by the first signal-receiving module according to the duration and the time interval further comprises:
pausing to record the output content of the currently selected channel until the duration is longer than the time interval.

3. The method of claim 1, further comprising:
supplying a second signal-receiving module to receive the multimedia stream corresponding to a plurality of channels and supplying an output content corresponding to a selected channel;
wherein the step of controlling a recording operation of an output content of the currently selected channel supplied by the first signal-receiving module according to the duration and the time interval further comprises:
pausing to record the output content of the currently selected channel until the duration is longer than the time interval; and
continuously recording the output content corresponding to the previously selected channel supplied by the second signal-receiving module until the duration is longer than the time interval.

4. The method of claim 1, further comprising:
supplying a second signal-receiving module to receive the multimedia stream corresponding to a plurality of channels and supplying an output content corresponding to a selected channel; and
recording the output content of the previously selected channel supplied by the second signal-receiving module;
wherein the step of controlling a recording operation of an output content of the currently selected channel supplied by the first signal-receiving module according to the duration and the time interval further comprises:
pausing to record the output content of the currently selected channel until the duration is longer than the time interval; and
after the output content of the currently selected channel is recorded, continuously recording the output content of the previously selected channel for at least a period time.

5. The method of claim 1, wherein the multimedia stream is a television signal source, and each channel is a television channel.

6. The method of claim 1, wherein the multimedia stream is a plurality of signal sources, and each signal source is a channel.

7. A system for utilizing at least one signal-receiving module to record multimedia programs, comprising:
a first signal-receiving module, for receiving a multimedia stream corresponding to a plurality of channels and supplying an output content corresponding to a selected channel;
a time-setting module, for setting a time interval;
a first recording module, coupled to the first signal-receiving module, for recording the output content of the currently selected channel; and
a processing module, coupled to the time-setting module and the first recording module, for when a user switches a previously selected channel to a currently selected channel, starting to count a duration corresponding to the currently selected channel, and controlling a recording operation of an output content of the currently selected channel supplied by the first signal-receiving module according to the duration and the time interval.

8. The system of claim 7, wherein when the duration of the currently selected channel is shorter than the time interval, the processing module controls the first recording module for pausing recording of the output content of the currently selected channel until the duration is longer than the time interval according to the duration and time interval.

9. The system of claim 7, further comprising:
a second signal-receiving module, for receiving a multimedia stream corresponding to a plurality of channels and supplying an output content corresponding to a selected channel;
wherein the processing module controls the first recording module for pausing recording of the output content of the currently selected channel until the duration is longer than the time interval according to the duration and time interval; and controls the first recording module for continuously recording the output content corresponding to the previously selected channel supplied by the second signal-receiving module until the duration is longer than the time interval.

10. The system of claim 7, further comprising:
a second signal-receiving module, for receiving a multimedia stream corresponding to a plurality of channels and supplying an output content corresponding to a selected channel; and
a second recording module, coupled to the processing module and the first signal-receiving module, for recording the output content of the previously selected channel supplied by the second signal-receiving module;
wherein the processing module controls the first recording module for pausing recording of the output content of the currently selected channel until the duration is longer than the time interval according to the duration and time interval; and after the output content of the currently selected channel is recorded, controls the second recording module to continuously record the output content of the previously selected channel for at least a period time.

11. The system of claim 7, wherein the multimedia stream is a television signal source, and each channel is a television channel.

12. The system of claim 7, wherein the multimedia stream is a plurality of signal sources, and each signal source is a channel.
